(19) United States
(12) Patent Application Publication
(10) Pub. No.: US 2009/0036123 A1
(43) Pub. Date: Feb. 5, 2009

(54) BAND SCANNING AND CELL SELECTION METHOD AND APPARATUS FOR MOBILE STATION

(75) Inventor: Gyoung Seok JEON, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/166,763

(22) Filed: Jul. 2, 2008

(30) Foreign Application Priority Data
Jul. 30, 2007 (KR) 2007-0076514

(51) Int. Cl. H04Q 7/20

(52) U.S. Cl. 455/434

(57) ABSTRACT

A band scanning and cell selection method and apparatus is provided for improving cell selection efficiency of a mobile station. A band scanning method includes scanning, when the mobile station transitions to a normal service state, a preset frequency band and attempting, when the preset frequency band is available, to connect the mobile station to a cell through the frequency band. A cell selection method of includes searching, when a public land mobile network is selected, for cells in the public land mobile network, creating a suitable cell list and an acceptable cell list with reference to the search result, and attempting, when failed to find a suitable cell or to camp on a suitable cell, to camp on one of acceptable cells listed on the acceptable cell list.

### PRIORITY

This application claims the benefit under 35 U.S.C. §119(a) of a Korean patent application filed in the Korean Intellectual Property Office on Jul. 30, 2007 and assigned Serial No. 2007-0076514, the entire disclosure of which is hereby incorporated by reference.

### BACKGROUND OF THE INVENTION

1. Field of the Invention

The present invention relates to a mobile station. More particularly, the present inventions relates to a band scanning and cell selection method and apparatus for a mobile station that is capable of improving cell selection efficiency.

2. Description of the Related Art

Global System for Mobile communications (GSM) is a 2nd Generation (2G) digital mobile communication system used across Europe and many other countries. GSM has been extended via General Packet Radio Services (GPRS) and a Universal Mobile Telecommunication System (UMTS) as a 3rd Generation (3G) digital mobile system to offer non-voice services, such as text messaging, internet browsing, multimedia services and the like.

Although UMTS is based on GSM, it uses Wideband Code Division Multiple Access (WCDMA) as a radio transmission technology. UMTS aims at a packet-based transmission of text, digitized voice, video and multimedia at data rates up to 2 Mbps. Unlike previous circuit-switched cellular telephone systems, UMTS is a packet-switched communication system. Therefore, a virtual connection is always available to any other end point in the network.

UMTS is being deployed as a 3G overlay to GSM networks, and GSM/GPRS will coexist with 3G UMTS for many years until UMTS is fully implemented.

In such an overlay cellular communication system, a mobile station crosses certain boundaries between different system cells. Whenever crossing the cell boundaries, the mobile station scans frequency bands and searches for a specific cell for maintaining services, thereby causing a system processing load.

Therefore, a need exists for an apparatus and method for reducing processing load in the overlay cellular communication system.

### SUMMARY OF THE INVENTION

An aspect of the present invention is to address the above problems and/or disadvantages and to provide at least the advantages described below. Accordingly, an aspect of the present invention is to provide a band scanning and cell selection method and apparatus that is capable of reducing processing load by improving band scanning and cell selection processes of a mobile station.

In accordance with an aspect of the present invention, a band scanning method for a mobile station is provided. The method includes scanning a preset frequency band in a normal service state, and connecting, when the preset frequency band is available, to a cell through the frequency band.

In accordance with another aspect of the present invention, a cell selection method for a mobile station is provided. The method includes searching, when a public land mobile network is selected, for cells in the public land mobile network, creating a suitable cell list and an acceptable cell list with reference to the search result, and attempting, when a suitable cell is failed to be found or camped on, to camp on one of acceptable cells listed on the acceptable cell list.

In accordance with another aspect of the present invention, a band scanning apparatus for a mobile station is provided. The apparatus includes a radio frequency unit for allowing the mobile station to connect to a mobile communication network, and a control unit for scanning, when the mobile station transitions to a normal service state, a preset frequency band and for attempting, when the preset frequency band is available, to connect the mobile station to a cell through the frequency band.

In accordance with another aspect of the present invention, a cell selection apparatus for a mobile station is provided. The apparatus includes a radio frequency unit for allowing the mobile station to connect to a mobile communication network and for searching for suitable cells of the network and acceptable cells, a storage unit for storing a suitable cell list listing the suitable cells and an acceptable cell list listing the acceptable cells, and a control unit for controlling the radio frequency unit to attempt, when a suitable cell is failed to be found or camped on, to camp on one of acceptable cells listed on the acceptable cell list.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a configuration of a mobile station according to an exemplary embodiment of the present invention;

FIG. 2 is a flowchart illustrating a band scanning method according to an exemplary embodiment of the present invention;

FIG. 3 is a timeline diagram illustrating a band scanning method according to an exemplary embodiment of the present invention;

FIG. 4 is a block diagram illustrating state transitions of a mobile station according to an exemplary embodiment of the present invention; and

FIG. 5 is a flowchart illustrating a cell selection method according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Although the band scanning and cell selection method and apparatus is described in association with a mobile station in the following description, the present invention is not limited thereto. For example, the mobile station can be any of a cellular phone, (such as a Code Division Multiple Access (CDMA) terminal, a UMTS terminal, a GSM terminal, and the like), a digital broadcast receiver, a Personal Digital Assistant (PDA), a Smartphone, a laptop computer and their equivalents supporting multi-band wireless communications.

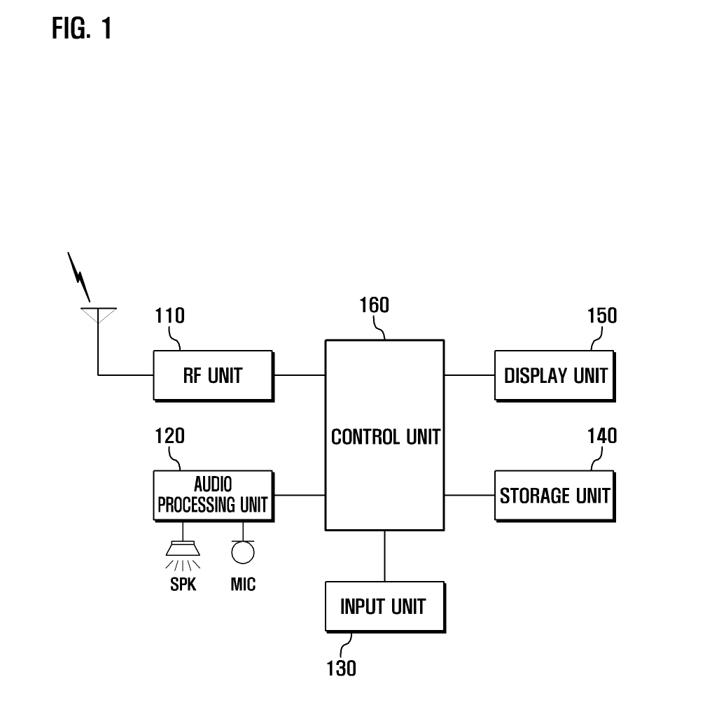

FIG. 1 is a block diagram illustrating a configuration of a mobile station according to an exemplary embodiment of the present invention.

Referring to FIG. 1, the mobile station includes a Radio Frequency (RF) unit 110, an audio processing unit 120, an input unit 130, a storage unit 140, a display unit 150 and a control unit 160.

The RF unit 110 is responsible for radio communication of the mobile station with another station. The RF unit 110 converts a modulated signal output by the control unit 160 into an intermediated frequency signal and then into a radio frequency signal to be transmitted to a base station through an antenna and converts a radio signal received through the antenna into an intermediate signal and then a baseband signal to be provided to the control unit 160.

In an exemplary implementation, the RF unit 110 can be implemented with two parts operating in respective 2G and 3G frequency bands. That is, the mobile station can be configured as a dual-band dual-mode terminal with a pair of 2G and 3G RF units.

The audio processing unit 120 processes audio data output by the control unit 160 and outputs the audio data through a speaker (SPK) in a form of an audible sound wave and processes an audio signal input through a microphone (MIC) and outputs the processed audio signal to the control unit 160.

The input unit 130 is provided with a plurality of alphanumeric keys for inputting alphanumeric data and a plurality of function keys for executing various functions of the mobile station. The function keys may be implemented in a form of navigation keys, side keys, and shortcut keys. The input unit 130 generates key signals in response to key inputs and transfers the key input signals to the control unit 160.

The storage unit 150 stores application programs associated with the band scanning and cell selection method according to an exemplary embodiment of the present invention.

The storage unit 150 may be divided into a program region and a data region. The program region stores an Operating System (OS) for booting the mobile station and application programs required for executing functions of the mobile station. The data region stores a suitable cell list and an acceptable cell list for use in the band scanning and cell selection method according to an exemplary embodiment of the present invention and related-information.

The display unit 150 displays menu screens, data input by a user, and active function status and user configuration information. The display unit 150 can be implemented with a Liquid Crystal Display (LCD). In this case, the display unit 150 may further include a LCD controller, a video memory for storing video data, and LCD devices. In a case that the LCD supports touchscreen functionality, the display unit 150 may act as a part of the input unit 130. More particularly, the display unit 150 may display link information when displaying a text message under the control of the control unit 160.

The control unit 160 controls general operations and signaling between internal elements of the mobile station. That is, the control unit 160 controls cooperative signaling among the RF unit 110, the audio processing unit 120, the input unit 130, the storage unit 140, and the display unit 150.

The control unit 160 processes the signals input through the input unit 130 (e.g., key signals generated by a keypad and touch signal generated by a touchscreen) such that the mobile station performs functions associated with the signals and displays information about function execution status, menu, and user data on the display unit 150.

The control unit 160 also performs channel coding and interleaving on the Pulse-Code Modulation (PCM) voice signal output by the audio processing unit 120 and outputs the coded data to the RF unit 110 and performs demodulation, equalization, channel decoding, and deinterleaving the signal received from the RF unit 110 and outputs the processed signal to the audio processing unit 120 in the form of PCM voice signal. To do so, the control unit 160 includes a modem (not shown) and a codec (not shown). The codec may include a data codec for processing packet data, an audio codec for processing the audio signal including voice, and a video codec for processing video signal.

Although not shown in the drawing, the mobile station may further include at least one of a memory slot for receiving an external storage media such as a memory card for extending data storage capability, a connection port for establishing a data connection with an external device, and a power charging port. Also, the mobile station may further include at least one multimedia module such as a broadcast receiver module, a camera module, a MP3 module and the like. Although not all the possible modules are described, it is obvious to those skilled in the art that various application modules can be included with the mobile station.

The operations of the above structured mobile station are described hereinafter in association with the band scanning and cell selection method according to an exemplary embodiment of the present invention.

The band scanning and cell selection method of an exemplary embodiment of the present invention is accomplished by taking into account that a mobile station rarely moves out of a preset frequency band area. For example, 1900/850 MHz UMTS/GSM are used in the United States, and 2100 MHz UMTS and 1800/900 MHz GSM are used in Europe. In the following, it is assumed that the United States is area A and its frequency band is referred to as band A and Europe is area B and its frequency band is referred to as band B. Since a user living in the United State may not move to Europe frequently, it is preferable to set the mobile station carried by the user with band A preference.

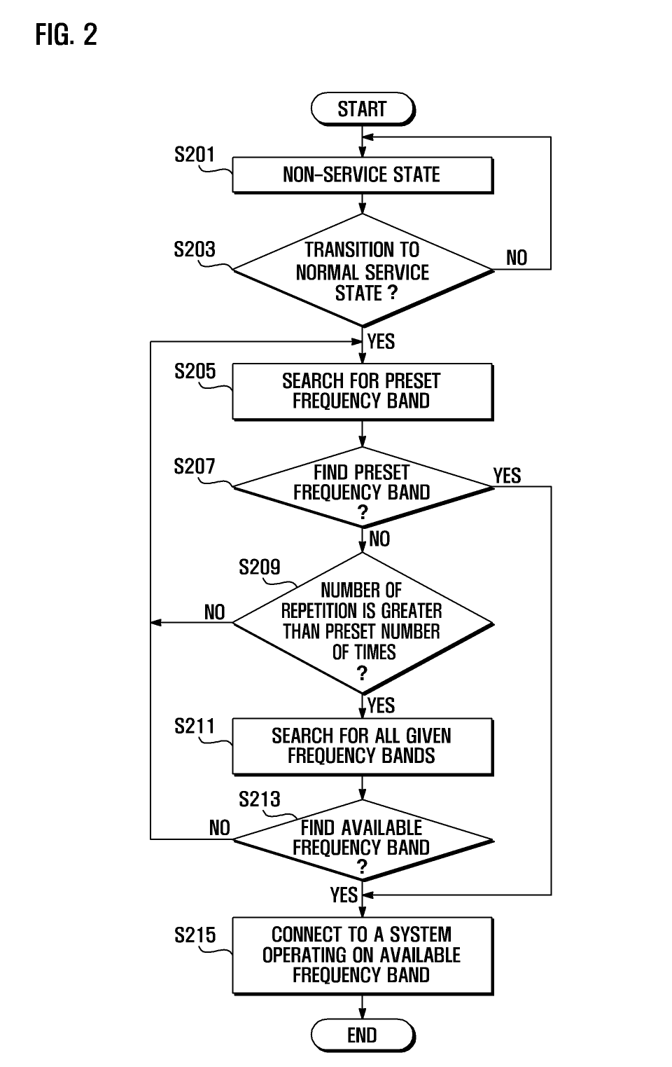

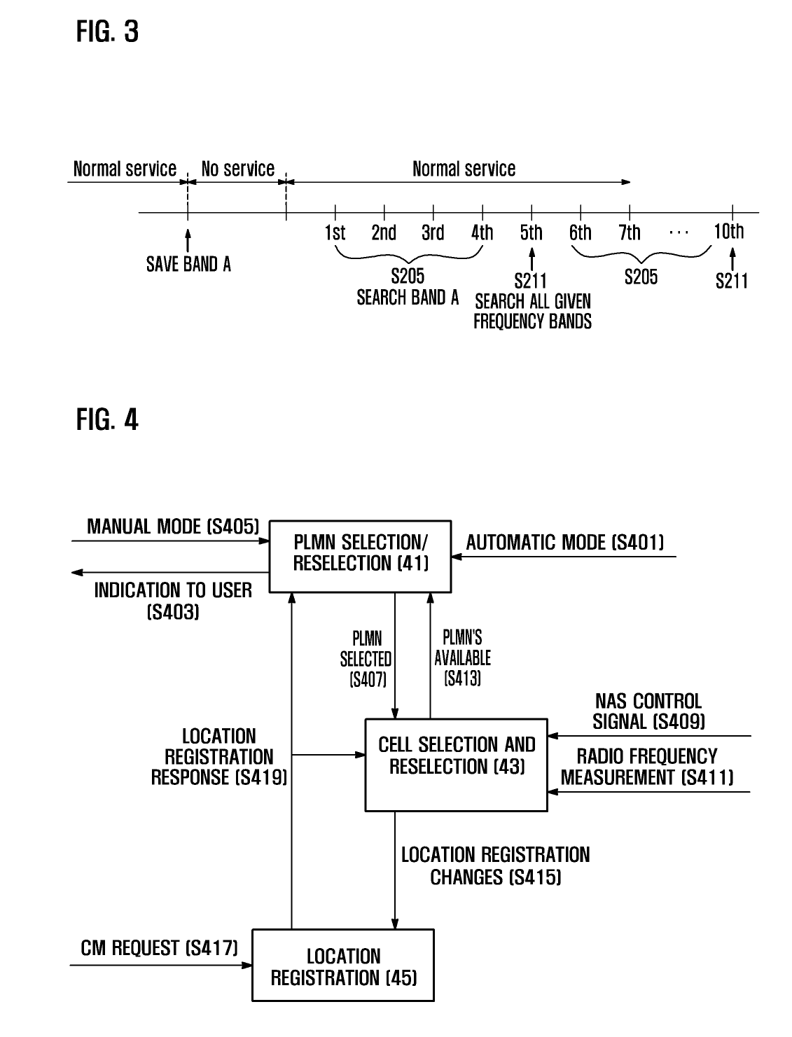

FIG. 2 is a flowchart illustrating a band scanning method according to an exemplary embodiment of the present invention, and FIG. 3 is a timeline diagram illustrating a band scanning method of FIG. 2.

In an exemplary embodiment, it is assumed that the mobile station transitions from a normal service state to a non-service state and then to the normal service state again. Also, it is assumed that, if the mobile station transitions from the normal service state to the non-service state, the control unit 160 of the mobile station stores the frequency band of the area in the non-service state. In FIG. 3, the band A is stored.

Referring to FIG. 2, in the band scanning method according to an exemplary embodiment of the present invention, the control unit 160 first detects that the mobile station is in a non-service state at step S201 and monitors to detect an event indicating transition to a normal service state at step S203. If a normal service state transition event is detected, the control unit 160 scans a preset band previously stored, e.g. band A at step S205.

Next, the control unit 160 determines whether the preset frequency band (band A) is found at step S207.

If the preset band is found, the control unit 160 establishes a connection with a system operating on the preset frequency band at step S215. In contrast, if the preset frequency band is not found, the control unit 160 repeats the search for the preset frequency band a preset number of times and determines whether a number of repetitions is greater than the preset number of times at step S209. If a number of repetitions is greater than the preset number of times, the control unit 160 searches all the given frequency bands, i.e. the bands A and B at step S211 and, otherwise, returns to step S205.

Although the preset number of times is set to four (4) in FIG. 3, the present invention is not limited thereto. The number of preset time may be changed by the user, a network operator and a manufacturer.

While searching for the bands A and B, the control unit 160 determines whether an available frequency band is found at step S213. If an available frequency band is detected, the control unit 160 establishes a connection to a system operating on the frequency band at step S215 and, otherwise, returns to step S205.

A cell selection method according to an exemplary embodiment of the present invention is described hereinafter.

In the following, an acceptable cell refers to a cell which may provide limited services such as an emergency call. Such an acceptable cell must not be restricted for an incoming call. A suitable cell must not be restricted for an incoming call and must not be a cell belonging to a forbidden area.

When the mobile station first powers on or enters another cell, the mobile station (i.e., user equipment or UE) selects or reselect a Public Land Mobile Network (PLMN). Next, the mobile station searches for a cell in the selected PLMN onto which it camps.

The mobile station camps on the cell for receiving system information from the PLMN. The mobile station also establishes a control channel with the camped-on cell for negotiating a radio connection and registering with the network. If the PLMN receives a call for the registered mobile station, it recognizes the registration area of the cell in which the mobile station is camped and sends a paging message for the mobile station on control channels of all the cells in the registration area. Accordingly, the mobile station may receive the paging message on the control channel and respond on the control channel. Consequently, the mobile station can receive cell broadcast messages.

In short, the mobile station camps on a base station of a specific cell and receives services provided by the base station. Due to the mobility of the mobile station, however, the communication path changes dynamically in a cell or between cells. Accordingly, a mobile station is required to perform cell selection and reselection.

The initial procedure including the cell selection is described with reference to the accompanying drawings.

FIG. 4 is a block diagram illustrating state transitions of a mobile station according to an exemplary embodiment of the present invention.

Referring to FIG. 4, the mobile station may operate in a PLMN selection/reselection state 41 for selecting/reselecting a PLMN, a cell selection/reselection state 43 for selecting/reselecting a cell, and a location registration state 45 for registering the location of the mobile station.

In the PLMN selection/reselection state 41, the mobile station may operate in an automatic mode or a manual mode. The automatic mode allows the mobile station to select a PLMN with reference to a preset value at step S401. In the manual mode, the mobile station displays PLMN selection information at step S403, such that the user selects a PLMN with reference to the PLMN selection information at step S405.

After the PLMN is selected, the mobile station enters the cell selection/reselection state 43 for selecting a suitable cell in the PLMN. The type of PLMN may differ depending on a Radio Access Technology (RAT). That is, the type of PLMN is determined depending on whether the network is 2G or 3G network. According to the type of the PLMN, different PLMN recognition schemes may be used. The PLMN type information is carried by the PLMN selection information at step S407. The mobile station receives a Non-Access Stratum (NAS) control signal at step S409 and measures radio frequency at step S411 to select/reselect a cell. If the cell is selected or reselected, the mobile station reports an available PLMN to the NAS at step S413.

If the location is changed by the cell selection/reselection, the mobile station enters the location registration state 45 by reporting the change of the location at step S415. Next, the mobile station receives a CM request at step S417 and sends a location registration response to the PLMN and the cell at step S419.

In a case that no suitable cell is found, the mobile station searches for an acceptable cell. A method to search for acceptable cell is described hereinafter.

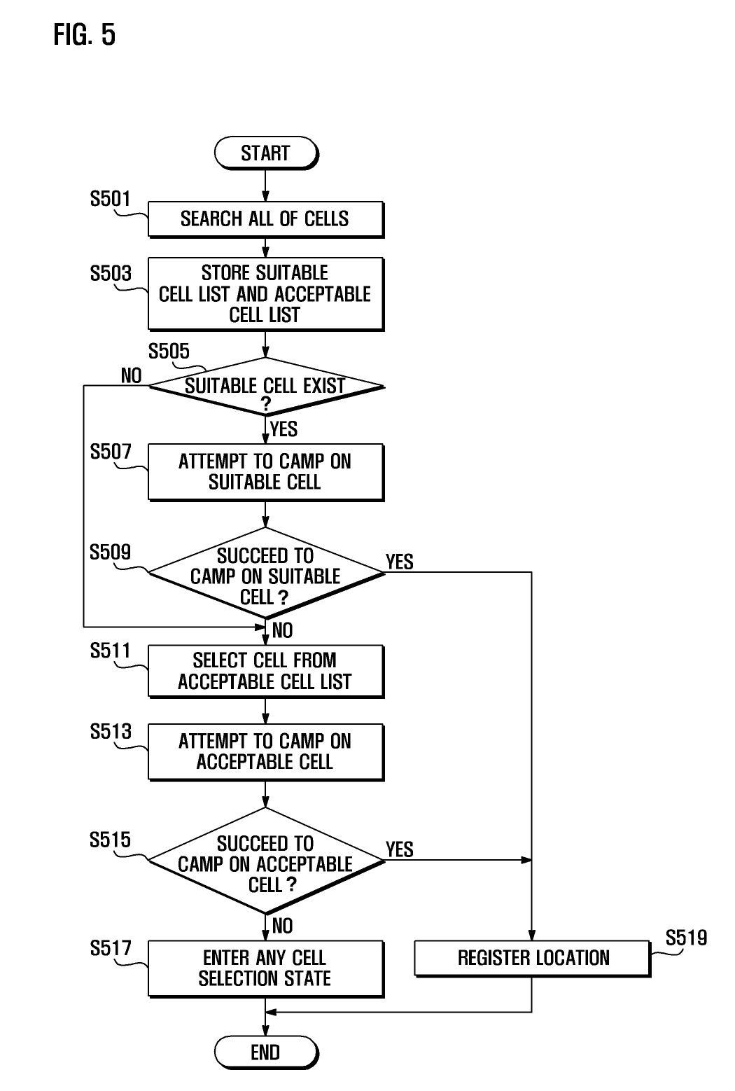

FIG. 5 is a flowchart illustrating a cell selection method according to an exemplary embodiment of the present invention. In this exemplary embodiment, it is assumed that the mobile station is in a state for selecting a suitable cell after selecting a PLMN.

Referring to FIG. 5, the control unit 160 of the mobile station searches for all of the cells by means of the RF unit 110 at step S501. As a result of the cell scanning, the control unit 160 updates a suitable cell list and an acceptable cell list and stores the suitable and acceptable cell lists in the storage unit 140.

Next, the control unit 160 determines whether a suitable cell on which the mobile station may camp exists at step S505. If a suitable cell on which the mobile station may camp exists, the control unit 160 attempts to camp on the suitable cell at step S507. Next, the control unit 160 determines whether the mobile station succeeds to camp on the suitable cell at step S509. If the mobile station succeeds to camp on the suitable cell, the control unit 160 registers its location and, otherwise, selects one of cells listed on the acceptable cell list at step S5 11 and attempts to camp on the selected acceptable cell at step S513. Next, the control unit 160 determines whether the mobile station succeeds to camp on the acceptable cell at step S515. If the mobile station succeeds to camp on the cell, the control unit 160 registers its location at step S519 and, otherwise, enters any cell selection state at step S517. In the any cell selection station, the control unit 160 repeats the scanning of the cells, updates the acceptable cell list, and attempts to camp on one of the cells listed on the acceptable cell list until the mobile station succeeds to camp on a cell.

As described above, the cell selection method of exemplary embodiments of the present invention finds all of the cells while searching for the suitable cells, stores information on the cells in the form of a suitable cell list and an acceptable cell list, and attempts to camp on one of the cells listed on the acceptable cell list when no suitable cell is found, thereby skipping a cell reselection process, resulting in a reduction of processing load of the mobile station.

While the present invention has been shown and described with reference to certain exemplary embodiments thereof, it will be clearly understood by those skilled in the art that many variations and/or modifications in the form and details may be made without departing from the spirit of the present invention as defined in the appended claims and their equivalents.

As described above, the band scanning and cell selection method and apparatus of exemplary embodiments of the present invention omits redundant processes in an initialization procedure of a mobile station, resulting in a reduction of processing load and an improvement of resource management efficiency.

What is claimed is:

1. A band scanning method for a mobile station, the method comprising:
scanning a preset frequency band in a normal service state; and
connecting, when the preset frequency band is available, to a cell through the frequency band.

2. The band scanning method of claim 1, further comprising:
rescanning, when the preset frequency band is unavailable, the frequency band at preset times; and
scanning, when the scanning of the preset frequency band is unsuccessful, all given frequency bands.

3. The band scanning method of claim 2, further comprising connecting, when the scanning of all available frequency bands is successful, the mobile station to a cell through the frequency band with which the scanning is successful.

4. A cell selection method for a mobile station, the method comprising:
searching, when a public land mobile network is selected, for cells in the public land mobile network;
creating a suitable cell list and an acceptable cell list with reference to the search result; and
attempting, when a suitable cell is failed to be found or camped on, to camp on one of acceptable cells listed on the acceptable cell list.

5. The cell selection method of claim 4, further comprising selecting the public land mobile network before the searching for the cells when the mobile station either turns on or enters into another cell.

6. The cell selection method of claim 5, wherein the mobile station operates in at least one of an automatic mode and a manual mode to connect to the communication network.

7. The cell selection method of claim 4, further comprising attempting, when the acceptable cell is failed to be camped on, to camp on another acceptable cell.

8. The cell selection method of claim 4, wherein the suitable cell comprises a cell belonging to the public land mobile network, provides a normal service, and has no reception restriction.

9. The cell selection method of claim 4, wherein the acceptable cell is a cell to originate an emergency call and has no reception restriction.

10. The cell selection method of claim 4, further comprising registering a location of the mobile terminal with the public land mobile network.

11. A band scanning apparatus for a mobile station, the apparatus comprising:
a radio frequency unit for allowing the mobile station to connect to a mobile communication network; and
a control unit for scanning, when the mobile station transitions to a normal service state, a preset frequency band and for attempting, when the preset frequency band is available, to connect the mobile station to a cell through the frequency band.

12. The band scanning apparatus of claim 11, wherein the control unit rescans, when the preset frequency band is unavailable, the frequency band at preset times and scans, when the scanning of the present frequency band is unsuccessful, all available frequency bands.

13. The band scanning apparatus of claim 12, wherein the control unit connects, when the scanning of the preset frequency band is successful, the mobile station to a cell through the frequency band with which the scanning is successful.

14. A cell selection apparatus for a mobile station, the apparatus comprising:
a radio frequency unit for allowing the mobile station to connect to a mobile communication network and for searching for suitable cells of the network and acceptable cells;
a storage unit for storing a suitable cell list listing the suitable cells and an acceptable cell list listing the acceptable cells; and
a control unit for controlling the radio frequency unit to attempt, when a suitable cell is failed be found or camped on, to camp on one of acceptable cells listed on the acceptable cell list.

15. The cell selection apparatus of claim 14, wherein the mobile station operates in at least one of an automatic mode and a manual mode to connect to the communication network.

16. The cell selection apparatus of claim 14, wherein the control unit controls the radio frequency unit to attempt, when the acceptable cell is failed to be camped on, to camp on another acceptable cell.

17. The cell selection apparatus of claim 14, wherein the suitable cell comprises a cell belonging to a public land mobile network, provides a normal service and has no reception restriction.

18. The cell selection apparatus of claim 14, wherein the acceptable cell is a cell to originate an emergency call and has no reception restriction.

19. The cell selection apparatus of claim 14, wherein the control unit registers a location of the mobile terminal with the public land mobile network.
